(19) United States
(12) Patent Application Publication
(10) Pub. No.: US 2015/0170218 A1
(43) Pub. Date: Jun. 18, 2015

(54) SYSTEMS AND METHODS FOR VALUE ADDED IN-STREAM CONTENT ADVERTISING

(71) Applicant: Yahoo! Inc., Sunnyvale, CA (US)

(72) Inventors: Supreeth RAO, Sunnyvale, CA (US); Sundeep Narravula, Sunnyvale, CA (US); Shivakumar Ningappa, Milpitas, CA (US)

(73) Assignee: Yahoo! Inc., Sunnyvale, CA (US)

(21) Appl. No.: 14/133,032

(22) Filed: Dec. 18, 2013

(51) Int. Cl. G06Q 30/02; G06F 17/30

(52) U.S. Cl. CPC G06Q 30/0269; G06F 17/30522

(57) ABSTRACT

A server system may include at least one non-transitory, processor-readable storage medium and at least one processor in communication with the at least one storage medium. The at least one storage medium may include at least one set of instructions for generating a value added in-stream contents (VAC) database for ad display. The at least one processor may be configured to execute the at least one set of instructions to receive an candidate article for display in a stream on a website; determine a sentiment of the candidate article towards a first subject matter associated with the article; classify the candidate article to a first type category based on the sentiment when the sentiment has a positive effect to a commercial success of a second subject matter; and generating a VAC database based on the first type category.

### BACKGROUND

This application relates generally to data processing systems. More particularly, this application relates to systems and methods for value added in-stream content advertising.

Online advertising has become increasingly popular as a way for advertisers to publicize information about goods and services to potential customers and clients. An advertiser can implement an advertising campaign using internet-accessible facilities of online providers such as Yahoo! Inc. The online provider serves to connect the advertiser with users accessing online resources such as search engines and news and information sites. Advertisements (“ads”) of the advertiser are provided to the users to inform and attract the attention of the users.

The online provider makes available a variety of marketplaces for advertisers to conduct an advertising campaign. For example, Yahoo! Inc. provides many of its popular web properties, such as its front page and home page, on personal computer (“PC”) and in applications (“apps”) on mobile platforms for advertising campaigns.

Stream display dominates these web pages of a few websites, such as www.yahoo.com. A stream display on a web page is a stream of content in which a sequence of items are displayed, one item after another, for example, down a web page viewed on a computer display or other device.

Streams are becoming common in online presentation because they provide added flexibility. If a stream is not used to present data on a web page, the web page must have pre-defined sections. Only certain types of information, having specified sizes, shapes or content, can be presented in the pre-defined sections. A stream allows any number and size and shape of content items to be included. The elements of the stream may be sorted by relevance or by any suitable parameter. A stream also lowers the cognitive load on the viewer when viewing content and advertisements on a web page.

Because the content shown on a stream display web page is highly personalized for a specific viewer, each item on these web pages has a higher likelihood to be viewed by the viewer. Thus a web page with stream display provides an excellent platform to explore a more personalized marketplace for its viewers.

### BRIEF SUMMARY

According to an aspect of the present disclosure, a server system may include at least one non-transitory, processor-readable storage medium and at least one processor in communication with the at least one storage medium. The at least one storage medium may include at least one set of instructions for generating a value added in-stream contents (VAC) database for ad display. The at least one processor may be configured to execute the at least one set of instructions to receive a candidate article for display in a stream on a website; determine a sentiment of the candidate article towards a first subject matter associated with the article; classify the candidate article to a first type category based on the sentiment when the sentiment has a positive effect to a commercial success of a second subject matter; and generating a VAC database based on the first type category.

According to another aspect of the present disclosure, a processor-implemented method for generating a value added in-stream contents (VAC) database for ad display may include receiving, by a processor, a candidate article for display in a stream on a website; determining, by a processor, a sentiment of the candidate article towards a first subject matter associated with the article; classifying, by a processor, the candidate article to a first type category based on the sentiment when the sentiment has a positive effect to a commercial success of a second subject matter; and generating, by a processor, a VAC database based on the first type category.

According to yet another aspect of the present disclosure, a non-transitory, processor-readable storage medium may include at least one set of instructions for generating a value added in-stream contents (VAC) database for ad display. The at least one set of instructions, when executed by at least one processor, may be configured to direct the at least one processor to perform acts of: receiving an candidate article for display in a stream on a website; determining a sentiment of the candidate article towards a first subject matter associated with the article; classifying the candidate article to a first type category based on the sentiment when the sentiment has a positive effect to a commercial success of a second subject matter; and generating a VAC database based on the first type category.

These and other advantages, aspects, and novel features of the present disclosure, as well as details of illustrated embodiments thereof, will be more fully understood from the following description and drawings.

### BRIEF DESCRIPTION OF THE DRAWINGS

FIG. 1 is a block diagram of an example online information system;

FIG. 2 is a schematic diagram illustrating an example embodiment of a server;

FIG. 3 is a schematic diagram illustrating an example embodiment of a client device;

FIG. 4 is an example illustrating a system for providing a web page with a stream display layout;

FIG. 5 is a schematic diagram of a content database under a hierarchical content taxonomy according to example embodiments of the present disclosure;

FIG. 6 is a flow chart illustrating a value added in-stream content marketplace for online advertising according to the example embodiments of the present disclosure;

FIG. 7 illustrates a flow chart of a method for generating a value added in-stream content database according to the example embodiments of the present disclosure;

FIG. 8 illustrates a mapping table that associates a value added in-stream content database with an ad database according to the example embodiments of the present disclosure; and

FIG. 9 illustrates a flow chart of a method for operating a value added in-stream content marketplace according to the example embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

An online information system places advertisements of advertisers within content services made available to end users, such as web pages, mobile applications (“apps”), TV apps, or other audio or visual content services. The advertisements are provided along with other content. The other content may include any combination of text, graphics, audio, video, or links to such content. The advertisements are conventionally selected based on a variety of criteria including those specified by the advertiser. The advertiser conventionally defines an advertising campaign to control how and when advertisements are made available to users and to specify the content of those advertisements. The content of the advertisements themselves is sometimes referred to as advertising creative or advertising creatives.

Various monetization techniques or models may be used in connection with sponsored advertising. In an auction type online advertising marketplace, advertisers may bid in connection with placement of advertisements, although other factors may also be included in determining advertisement selection or ranking. Bids may be associated with amounts advertisers pay for certain specified occurrences, such as for placed or clicked on advertisements, for example. Advertiser payment for online advertising may be divided between parties including one or more publishers or publisher networks, one or more marketplace facilitators or providers, or potentially among other parties.

Some models may include Guaranteed Delivery advertising, in which advertisers may pay based at least in part on an agreement guaranteeing or providing some measure of assurance that the advertiser will receive a certain agreed upon amount of suitable advertising, or non guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression (CPM) or number of impressions, cost per click or number of clicks (CPC), cost per action (CPA) for some specified action(s), cost per conversion or purchase, or cost based at least in part on some combination of metrics, which may include online or offline metrics.

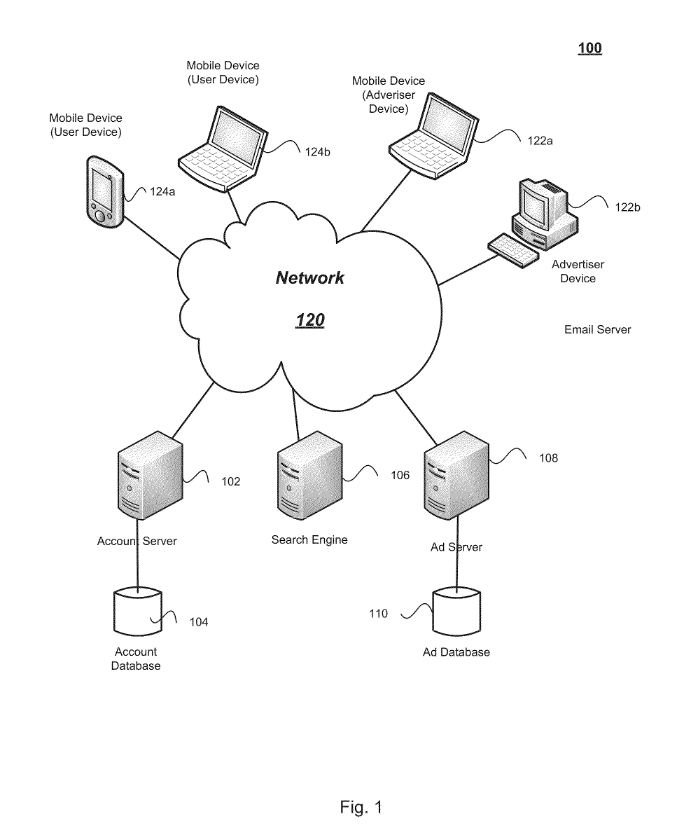

FIG. 1 is a block diagram of an online information system 100. The online information system 100 in the example embodiment of FIG. 1 may include an account server 102, and account database 104, a search engine 106, an advertisement (ad) server 108, and an ad database 110. The online information system 100 may be accessible over a network 120 by one or more advertiser devices, such as advertiser device 122a, 122b, and by one or more user devices, such as user device 124a, 124b. In various examples of such an online information system, users may search for and obtain content from sources over the network 120. Advertisers may provide advertisements for placement on web pages and other communications sent over the network to user devices such as the user device 124a, 124b. The online information system in one example may be deployed and operated by an online provider such as Yahoo! Inc.

The account server 102 may store account information for advertisers. The account server 102 may be in data communication with the account database 104. Account information may include one or more database records associated with each respective advertiser. Any suitable information may be stored, maintained, updated and read from the account database 104 by the account management server 102. Examples include advertiser identification information, advertiser security information such as passwords and other security credentials, and account balance information. In some embodiments, an online provider which manages the online information system 100 may assign one or more account managers to a respective advertiser, and information about the one or more account managers may be maintained in the account database 104 as well as information obtained and recorded for subsequent access by an account manager.

The account server 102 may be implemented using any suitable device. For example, the account management server 102 may be implemented as a single server, a plurality of servers, or any other type of computing device known in the art. Access to the account server 102 may be accomplished through a firewall, not shown, which protects the account management programs and the account information from external tampering. Additional security may be provided via enhancements to the standard communications protocols such as Secure HTTP or the Secure Sockets Layer.

The account server 102 may provide an advertiser front end to simplify the process of accessing the account information of an advertiser. The advertiser front end may be a program, application or software routine that forms a user interface. According to the example embodiments of the present disclosure, the advertiser front end may be accessible as a web site with one or more web pages that an accessing advertiser may view on an advertiser device such as advertiser device 122a, 122b. The advertiser may view and edit account data using the advertiser front end. After editing the advertising data, the account data may then be saved to the account database 104.

The search engine 106 may be a computer system, one or more servers, or any other computing device known in the art. Alternatively, the search engine 106 may be a computer program, instructions, or software code stored on a computer-readable storage medium that runs on a processor of a single server, a plurality of servers, or any other type of computing device known in the art. The search engine 106 may be accessed, for example, by user devices such as the user device 124a, 124b operated by a user over the network 120. The user device 124a, 124b may communicate a user query to the search engine 106. The search engine 106 may locate matching information using any suitable protocol or algorithm and returns information to the user device 124a, 124b. The search engine 106 may be designed to help users find information located on the Internet or an intranet. According to the example embodiments of the present disclosure, the search engine 106 may also provide to the user device 124a, 124b over the network 120 a web page with content including search results, information matching the context of a user inquiry, links to other network destinations or information and files of information of interest to a user operating the user device 124a, 124b.

The search engine 106 may enable a device, such as the user device 124a, 124b or any other client device, to search for files of interest using a search query. Typically, the search engine 106 may be accessed by a client device via one or more servers or directly over the network 120. The search engine 106 may, for example, comprise a crawler component, an indexer component, an index storage component, a search component, a ranking component, a cache, a profile storage component, a logon component, a profile builder, and one or more application program interfaces (APIs). The search engine 106 may be deployed in a distributed manner, such as via a set of distributed servers, for example. Components may be duplicated within a network, such as for redundancy or better access.

The ad server 108 may operate to serve advertisements to user devices such as the user device 124a, 124b. Advertisements include data defining advertisement information that may be of interest to a user of a user device. An advertisement may include text data, graphic data, image data, video data, or audio data. An advertisement may further include data defining one or more links to other network resources providing such data. The other locations may be other locations on the internet, other locations on an intranet operated by the advertiser, or any access.

For online information providers, advertisements may be displayed on web pages resulting from a user-defined search based at least in part upon one or more search terms. Advertisements may also be displayed based on content of a webpage that the user opens. Advertising may be beneficial to users, advertisers or web portals if displayed advertisements are relevant to interests of one or more users.

The ad server 108 may include logic and data operative to format the advertisement data for communication to the user device. The ad server 108 may be in data communication with the ad database 110. The ad database 110 may store information including data defining advertisements to be served to user devices. This advertisement data may be stored in the ad database 110 by another data processing device or by an advertiser.

Further, the ad server 108 may be in data communication with the network 120. The ad server 108 may communicate ad data and other information to devices over the network 120. This information may include advertisement data communicated to a user device. This information may also include advertisement data and other information communicated with an advertiser device such as the advertiser device 122a, 122b. An advertiser operating an advertiser device may access the ad server 108 over the network to access information including advertisement data. This access may include developing advertisement creatives, editing advertisement data, deleting advertisement data and other activities.

The ad server 108 may provide an advertiser front end to simplify the process of accessing the advertising data of an advertiser. The advertiser front end may be a program, application or software routine that forms a user interface. In one particular embodiment, the advertiser front end is accessible as a web site with one or more web pages that an accessing advertiser may view on the advertiser device. The advertiser may view and edit advertising data using the advertiser front end. After editing the advertising data, the advertising data may then be saved to the ad database 110 for subsequent communication in advertisements to a user device.

The advertisement server 108 may be a computer system, one or more servers, or any other computing device known in the art. Alternatively, the advertisement server 108 may be a computer program, instructions and/or software code stored on a computer-readable storage medium that runs on a processor of a single server, a plurality of servers, or any other type of computing device known in the art.

The account server 102, the search engine 106, and the ad server 108, may be implemented as any suitable computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

The network 120 may include any data communication network or combination of networks. A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network such as the network 120. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

The advertiser device 122a, 122b may include any data processing device which may access the online information system 100 over the network 120. The advertiser device 122a, 122b may be operative to interact over the network 120 with the account server 102, the search engine 106, the ad server 108, content servers and other data processing systems. The advertiser device 122a, 122b may, for example, implement a web browser for viewing web pages and submitting user requests. The advertiser device 122a, 122b may communicate data to the online information system 100, including data defining web pages and other information. The advertiser device 122a, 122b may receive communications from the online information system 100, including data defining web pages and advertising creatives.

The user device 124a, 124b may include any data processing device which may access the online information system 100 over the network 120. The user device 124a, 124b may be operative to interact over the network 120 with the search engine 106. The user device 124a, 124b may, for example, implement a web browser for viewing web pages and submitting user requests. A user operating the user device 124a, 124b may enter a search request and communicate the search request to the online information system 100. The search request may be processed by the search engine and search results may be returned to the user device 124a, 124b. In other examples, a user of the user device 124a, 124b may request data such as a page of information from the online information processing system 100. The data instead may be provided in another environment such as a native mobile application, TV application, or an audio application. The online information processing system 100 may provide the data or re-direct the browser to another web site. In addition, the ad server may select advertisements from the ad database 110 and include data defining the advertisements in the provided data to the user device 124a, 124b.

The advertiser device 122a, 122b and the user device 124a, 124b may operate as a client device when accessing information on the online information system. A client device such as the advertiser device 122a, 122b and the user device 124a, 124b may include a computing device capable of sending or receiving signals, such as via a wired or a wireless network. A client device may, for example, may include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. In the example of FIG. 1, a laptop computer 124b and a smartphone 124a may be operated interchangeably as an advertiser device or as a user device.

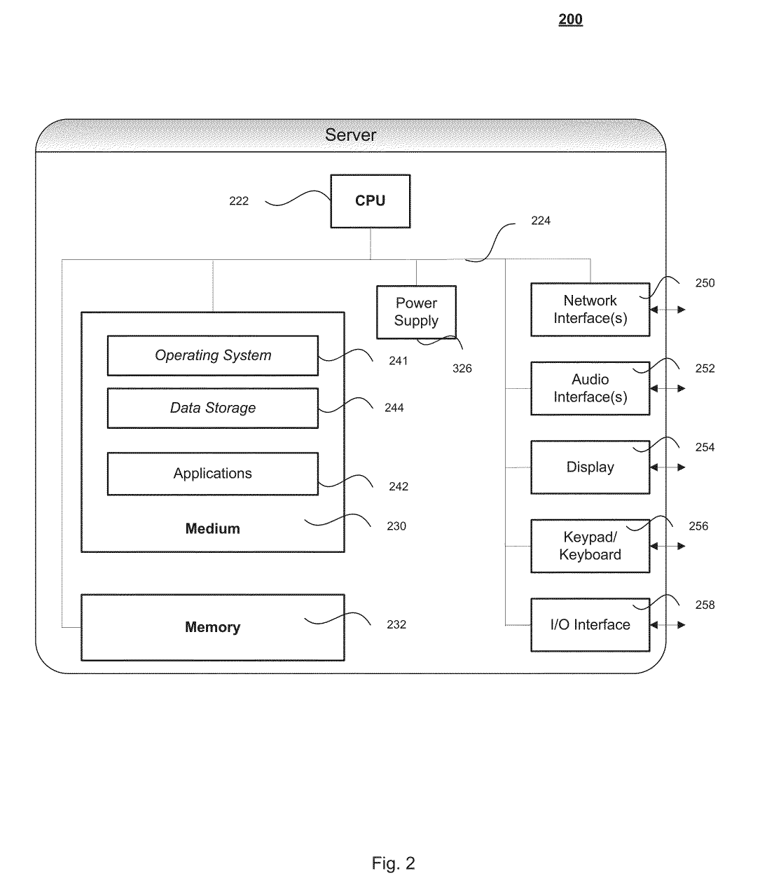

FIG. 2 is a schematic diagram illustrating an example embodiment of a server 200. The server 200 may be used as the account server 102, the search engine 106, and the ad server 108 of FIG. 1. A server 200 may vary widely in configuration or capabilities, but it may include one or more central processing units 222 and memory 232, one or more media 230 (such as one or more mass storage devices) storing application programs 242 or data 244, one or more power supplies 226, one or more wired or wireless network interfaces 250, one or more input/output interfaces 258, and/or one or more operating systems 241, such as Windows Server™, Mac OS X™, Unix™′ Linux™, FreeBSD™, or the like. Thus a server 200 may include, as examples, dedicated rack-mounted servers, desktop computers, laptop computers, set top boxes, mobile computational devices such as smart phones, integrated devices combining various features, such as two or more features of the foregoing devices, or the like.

The account server 102, the search engine 106, and the ad server 108 illustrated in FIG. 1 may be implemented as content servers or may be in communication with content servers. A content server may include a device that includes a configuration to provide content via a network to another device. A content server may, for example, host a site, such as a social networking site, examples of which may include, but are not limited to, Flicker™, Twitter™, Facebook™, LinkedIn™, or a personal user site (such as a blog, vlog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc. The content servers may not be under common ownership or control with the ad server or servers.

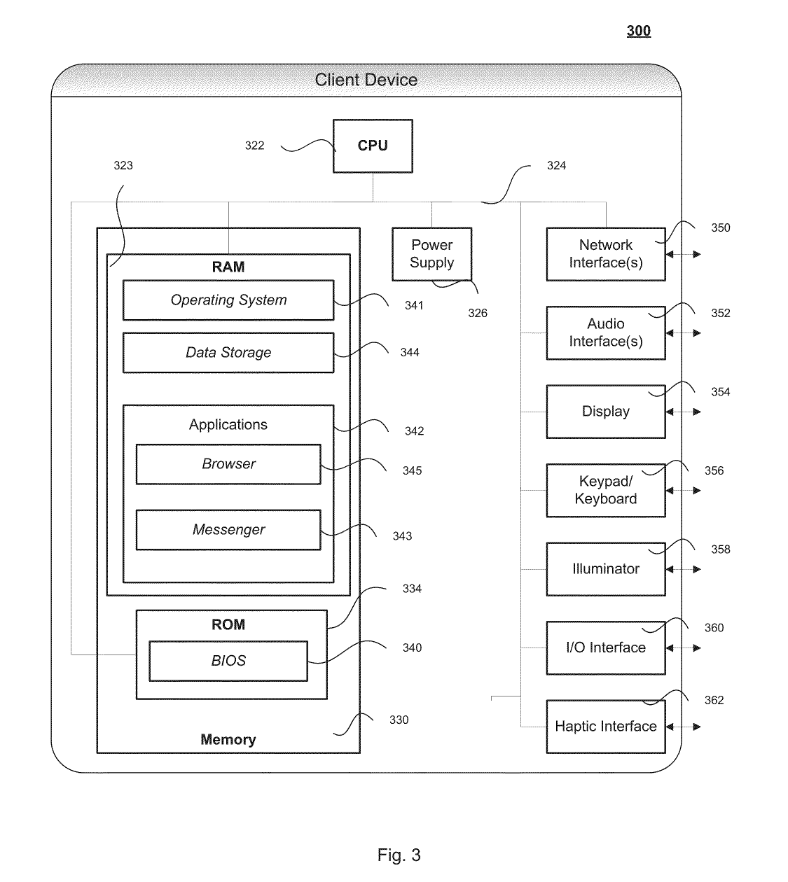

FIG. 3 is a schematic diagram illustrating an example embodiment of a client device that may be used as the user device 124a, 124b and the advertiser device 122a, 122b. The client device may include apparatuses to execute methods and software systems introduced in the present disclosure. A client device 300 may be a computing device capable of executing a software system. The client device 300 may, for example, be a device such as a personal desktop computer or a portable device, such as a laptop computer, a tablet computer, a cellular telephone, or a smart phone.

The client device 300 may vary in terms of capabilities or features. Claimed subject matter is intended to cover a wide range of potential variations. For example, the client device 300 may include a keypad/keyboard 356. It may also include a display 354, such as a liquid crystal display (LCD), or a display with a high degree of functionality, such as a touch-sensitive color 2D or 3D display. In contrast, however, as another example, a web-enabled client device 300 may include one or more physical or virtual keyboards, and mass storage medium 330.

The client device 300 may also include or may execute a variety of operating systems 341, including an operating system, such as a Windows™ or Linux™, or a mobile operating system, such as iOS™, Android™, or Windows Mobile™. The client device 300 may include or may execute a variety of possible applications 342, such as an electronic game 345. An application 342 may enable communication with other devices via a network, such as communicating with another computer, another client device, or server via a network.

Further, the client device 300 may include one or more non-transitory processor-readable storage media 330 and one or more processors 322 in communication with the non-transitory processor-readable storage media 530. For example, the non-transitory processor-readable storage media 330 may be a RAM memory, flash memory, ROM 334, 340 memory, EPROM memory, EEPROM memory, registers, hard disk, a removable disk, a CD-ROM, or any other form of non-transitory storage medium known in the art. The one or more non-transitory processor-readable storage media 330 may store sets of instructions, or units and/or modules that include the sets of instructions, for conducting operations and/or method steps described in the present disclosure. Alternatively, the units and/or modules may be hardware disposed in the client device 300 configured to conduct operations and/or method steps described in the present disclosure. The one or more processors may be configured to execute the sets of instructions and perform the operations in example embodiments of the present disclosure.

Merely for illustration, only one processor will be described in client devices and servers that execute operations and/or method steps in the following example embodiments. However, it should be note that the client devices and servers in the present disclosure may also include multiple processors, thus operations and/or method steps that are performed by one processor as described in the present disclosure may also be jointly or separately performed by the multiple processors. For example, if in the present disclosure a processor executes both step A and step B, it should be understood that step A and step B may also be performed by two different processors jointly or separately in the client device (e.g., the first processor executes step A and the second processor executes step B, or the first and second processors jointly execute steps A and B).

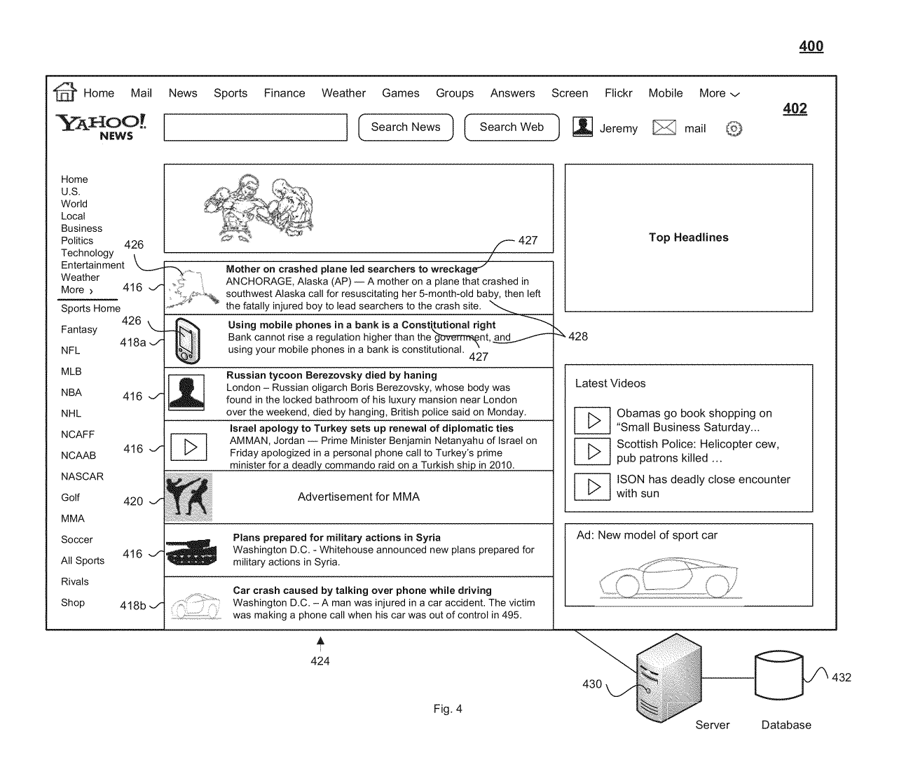

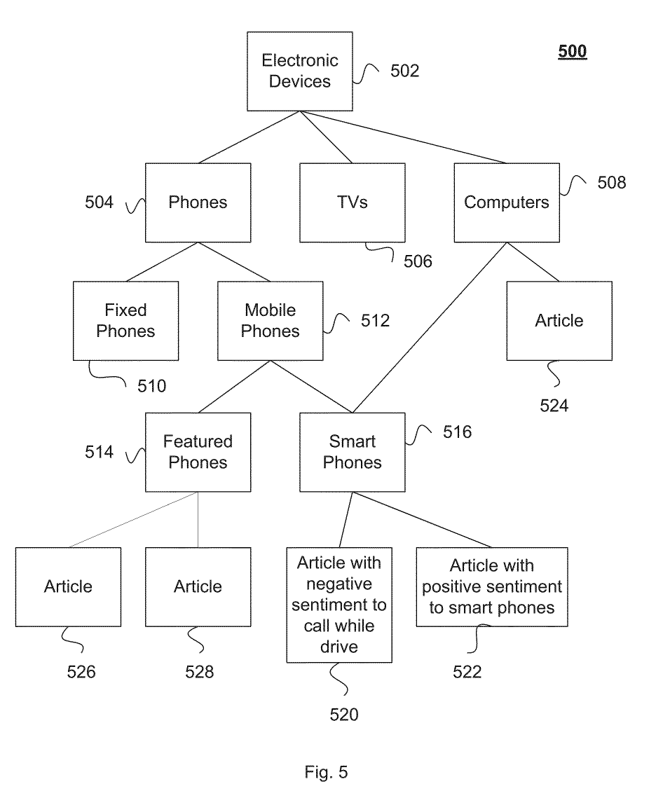

FIG. 4 is an example illustrating a system 400 for providing a web page with a stream content layout. This figure will be introduced in conjunction with FIG. 5, which is a schematic diagram of a content database 500.

The system 400 may include at least one server 430. The server 430 may be a cumulative representation of the servers 102, 106, and 108 in FIG. 1 or may be a cumulative representation of a part of these servers. The server 430 may be in communication with at least one database 432 to provide data for a web page 400. The database 432 may include a content database, including a plurality of articles to be displayed on the web page 400. The articles may be any form of content items. For example, the articles may be textual items (e.g., textual reports, stories, etc.) or contents of multimedia (e.g., audio/video clips) or a combination thereof. The database 432 may also include an ad database, including a plurality of ads to be displayed in the website. The database 432 may be stored in a non-transitory processor-readable storage medium in communication with the server 430. The web page 402 may be a front page, landing page, or a web page of a specific topic (e.g., sports, finance, news etc.) of a website. The web page 402 may be displayed on a browser of a user device 124a, 124b.

The web page 402 may include a column of stream 424, which may be positioned in the center column of the web page. The stream 424 may include a stream of slots, in which a sequence of items 416, 418a, 418b, 420 is displayed, one item after another. Each item 416, 418a, 418b, or 420 may include a textual summary 426 of the item. The item 416, 418, or 420 may also include graphics 426, other data, and a link 427 to additional information of the item. Clicking or otherwise selecting the link 427 may re-direct the browser on the user device 124a, 124b to a web page with the additional information.

The stream 424 of items 416, 418, 420 may include any type of content items. For example, the stream 424 may include articles 416, 418a, 418b, and ads 420. The articles 416, 418a, 418b may include news, business-related articles, sports-related articles, etc. In addition to textual or graphical content, the articles 416, 418a, 418b may include other data, such as audio and video data or applications.

The articles 416, 418a, 418b may be individually selected for the user that is viewing the web page. Different users may see different lists of articles 416, 418a, 418b or other content items in the column of stream 424 even if the users are visiting the same web page. For example, if user A is a fan of automobiles, the articles 416, 418a, 418b displayed on the web page may be automobile related. Another user, user B, may not see the same listing of articles 416, 418a, 418b as user A does because user B may not have the same passion for automobile as user A does.

The articles 416, 418a, 418b may be selected from at least one content database 432 by the server 430. The content database 432 may be generated by the server 430 of the web page 402 or an independent server (not shown). Further, the content database 432 may be organized as a hierarchical taxonomy, such as Yahoo! Content Taxonomy (YCT).

FIG. 5 is a schematic diagram of a content database 500 under a hierarchical content taxonomy according to the example embodiments of the present disclosure. The content database 500 may serve as the content database 432 for in-stream article selection as shown in FIG. 4. The content database 500 may include a plurality of articles 520, 522, 524, 526, 528. Content of each article may relate to at least one topic. For example, articles 520, 522 may relate to smart phones; article 524 may relate to computers; and articles 526, 528 may relate to featured phones.

When an article 520, 522, 524, 526, 528 is first received by the server 430, the server may analyze and determine contents and/or themes of the articles 520, 522, 524, 526, 528. The analysis may be based on keywords comparison or based on context semantic analysis. The present disclosure intends to cover the broadest technologies in content analysis available before and after the time of the filing of the present disclosure. For example, the server may search through the content of the article for specific keywords and compare the specific keywords with a keyword database to determine whether the context of the keywords is related to specific content or theme. The keyword searched in the article may be a single word, a phrase, a continued string of words, or any form feasible to content analysis that can be reasonably perceived by one of ordinary skill in the art at the time of the filing of this disclosure. The keyword database may be saved in at least one non-transitory processor-readable storage medium in communication with the server, and may include a plurality of reference keywords organized under a variety of categories of content and/or theme. By comparing the searched keyword in the article and reference keywords in the keyword database (e.g., vector comparison), the server may determine the content or themes of the article.

Based on the contents and/or themes, the server may classify each of articles 520, 522, 524, 526, 528 into a category. For example, the server may determine that articles 520, 522, 524, 526, 528 all relate to electronic devices, therefore classifying and/or categorizing the articles 520, 522, 524, 526, 528 under an “Electronic Devices” category 502.

The server may further refine the categorization until the lowest level categories are detailed enough to sufficiently distinguish the articles. For example, in FIG. 5 the “Electronic Device” category 502 is further divided as “Phones” 504, “TVs” 506, and “Computers” 508. The “Phone” category 504 is further divided as “Fixed Phones” 510 and “Mobile Phones” 512, which are further divided as “Featured Phones” 514 and “Smart Phones” 516. As a result, articles 520, 522 are eventually categorized under “Smart Phones” 516; articles 526, 528 are eventually categorized under “Featured Phones” 514; and article 534 is eventually categorized under “Computers” 508.

Further, depending on their content and/or themes, some categories or articles may be cross-categorized. For example, the category “Smart Phones” 516 is under “Mobile Phones” 512 but may also be a sub-category of “Computer” 508; and an article of smart phone (e.g., articles 520, 522) may also be categorized under “Computer” 508 directly or indirectly.

The articles 416, 418a, 418b may further be selected based on historical online activity information of a user. Several methods may be adopted to obtain the historical online activity information of the user. For example, the server of the web page may employ demographic characteristics (e.g., age, income, sex, occupation, etc.) of the user for predicting user behavior, such as by group. Contents of the articles 416, 418a, 418b may be selected and presented to users in a targeted audience based at least in part upon a match between the selected contents and predicted user behavior.

Another approach of the content selection may include profile-type content targeting. In this approach, user profiles specific to a user may be generated to model user behavior, for example, by tracking a user's path through a web site or network of sites, and compiling a profile based at least in part on pages ultimately delivered. A correlation may be identified, such as for user purchases, for example. An identified correlation may be used to target potential viewers by targeting content to particular users.

The historical online activities, such as the demographic information and browsing path of the user, may be obtained through various methods. For example, the server may generate an entry to a cookie file in the user device 124a, 124b every time when the user visits the website. The entry may record the time and web page and/or content of the web page that the user browses in the website, so that the server may be able to collect the browsing history of the user in the website and generate a profile for the user. The profile information may also be obtained if the user has an account on the website, in which the user discloses his/her personal information, such as name, age, gender, occupation etc.

To obtain the online activity history of the user in other websites, the server 430, or a third party data collector, may also embed a tracking application, such as an invisible pixel, to a third party website (or a particular web page of the third party website) before the user visits the third party website. The tracking application may include an identification that associates the tracking application with the third party website. Further, the tracking application may be configured to generate an entry in a cookie file of the user device when the user visits the third party website, wherein the entry may record the identification of the tracking application as well as the online activity of the user in the third party website. Accordingly, because the server 430 or the third party data provider knows that a particular tracking application is embedded in a particular website and knows the identification of the particular tracking application, by accessing to the entry of the cookie file, the server 430 or the third party data collector may be able to retrieve the online activity of the user in the third party website. The server 430 may be able to tracking the online activity information either by itself or by buying the online activity information from the third party data collector.

Because each article in the stream 424 displayed on the webpage 402 is specifically selected for the user, the likelihood of the articles being clicked and read by the user is greater.

The articles 416, 418a, 418b in the stream of content listed on the web page 402 may be further categorized and/or distinguished as articles of ordinary in-stream content (010) 416 and articles with value added in-stream contents (VAC) 418. A VAC article 418a, 418b may be an article that has a positive sentiment towards a subject matter, wherein the positive sentiment may have a positive effect to commercial success of a product and/or service of an advertiser. The subject matter may relate to a brand, a product, a company, a service provided by the company, or a category that the brand, the product, the company, and/or the service belong to. The brand, product, company, service and category thereof may be stored in a non-transitory processor-readable medium as categories in an ad database 432 for the server 430 to access.

The sentiment may be a feeling, a judgment prompted by the feeling, an attitude, a through, a notion, and/or an opinion towards a subject matter. It may reflect an emotional aspect of the article towards the subject matter. The sentiment may relate to the theme of the article, or may be collateral of the theme of the article (e.g., the sentiment may be a notion, attitude, or opinion to a side topic of the article). For example, a product review in an article, naming a product by brand or model, may express a positive or negative sentiment towards the product, the brand, and even the company that commercializes the product. If the product review is the main topic in an article, the corresponding sentiment may be the main sentiment in the article as well. If the product review is only mentioned as a collateral topic, or the product review is a post that following the article, the corresponding sentiment may be collateral as well. Similarly, a news story about use of a product or service may express a positive or negative sentiment, based on the writer's experience with the product or service, or the experience of the subject of the news story.

The sentiment may be direct and obvious, or may be subtle, indirect, and indicative so that it may only be drawn from further logical analysis based on the context of the article as a whole (e.g., the sentiment can only be concluded by a combination of facially unrelated facts within or without the article). For example, a news story reporting that a driver survived in a severe car accident caused by an unusual storm may include a picture showing a seriously damaged. A picture in the article shows that the driver was driving a Volvo™ vehicle when the accident occurred. Although the story does not mention the brand Volvo™ and does not mention that the accident was not caused by a malfunction of the Volvo™ vehicle. The fact that the accident is caused by unusual weather indicates that the Volvo™ vehicle functioned normally at the time of the accident. The combination of the fact that the accident was not caused by malfunction of the Volvo™ vehicle and the drive survived may form a positive sentiment towards the safety and reliability of the brand of Volvo™.

The sentiment may have a positive effect to the commercial success of a product, service, brand, or category thereof. For example, a product review that praises a product or a fame of a company may have a positive effect to the commercial success of the product, the company that promoting the product, or the company being praised. A sentiment being negative to a product may also have a positive effect the commercial success of another product, service, brand, or category thereof. For example, a news story reporting that traditional toothbrush cannot effectively clean residual food between a person's teeth may have a negative sentiment towards toothbrush but may have a positive effect to the commercial success of products that solve the cleaning problem, such as a flossing machine.

The sentiment of the article may be determined by a sentiment analyzer, such as the server 430, an independent computer, or a program executed thereby. The sentiment analyzer may determine the sentiment of the article by keywords analysis or by semantic analysis. For example, the server 430 may browse through the article and exam each word, phrase, or paragraph, comparing them with a bag of words (e.g., a database of keywords and/or key phrase) in the sentiment analyzer. The sentiment analyzer may adopt a learning algorithm and weight every word in the article for positive and negative sentiment towards a subject matter mentioned in the article based on a test dataset, and then assign a corresponding sentiment to the article.

Further, when the user reads the article, the server 430 may provide an ad associated with the subject matter on the web page contains the article. For example, an article that has a positive attitude or opinion towards a model of Dodge car may be categorized as a VAC article. The article may be selected from the content database 432 and placed in the stream 424 as article 418b together with other OIC articles 416, based on the historical online activities of a user that opens the web page 400. When a user selects and reads the article 418b, the server 430 or another server (not shown) may provide an ad for Dodge vehicles on the webpage (not shown) of the article 418b.

The VAC articles 418a, 418b may be displayed in a predetermined position (e.g., a predetermined slot) of the stream 424. For example, the stream 424 in the web page 402 may include 175 slots 416,418a, 418b for the list of items, wherein each slot is a piece of area in the stream 424 to display an item. Among the 175 slots, 5 slots may be used to display the VAC articles 418a, 418b and 8 slots of the 175 slots may be used to display advertisements 420. The remaining 162 slots may be used to display OIC articles.

The VAC articles 418a, 418b may adopt a different format from the OIC articles so that a user of the web page 402 may distinguish the VAC articles from the OIC articles. Alternatively, the VAC articles 418a, 418b may adopt a same format as the OIC articles 416 so that a user will not distinguish the VAC articles 418a, 418b from the OIC articles 416. For example, like the OIC articles 416, each VAC article 418a, 418b may include a textual content summary 428, a photo 426 beside the textual summary to highlight the content of the article, and a link 427 to a landing page (not shown) showing the full article. Clicking the link 428 may re-direct the browser on the user device 124a, 124b to the landing page.

The VAC articles 418a, 418b may be selected from a VAC article pool. The VAC article pool may be organized as a VAC database. The VAC database may be independent from the content database 432 or may be a sub-database of the content database 432. For example, after the content database 500 is generated, a content ingestion engine (e.g., a server, not shown) may further analyze each article in the database 500. To this end, the content ingestion engine may determine that an article is a VAC article if it includes a sentiment positive towards the major subject matter of the article, the content category that the article belongs to, or subject matter that is collateral to the major subject matter, so that the sentiment has a positive effect to a company, a brand, a product, and/or a service, or a category thereof. When the content ingestion engine finds a VAC article, it may add a tag to the article highlighting the positive sentiment to associate the article with the company, brand, product, and/or service, or a category thereof. Based on the tag, the content ingestion engine may classify the VAC article and organize the VAC article into the VAC database, dependent or independent from the database 500. For example, in FIG. 5, article 522 may have content that using mobile phone in a bank is constitutional. The content ingestion engine may determine that the article 522 may have a positive sentiment to mobile phones. Accordingly, the content ingestion engine may add to the article 522 a tag including this sentiment.

Additionally, the content ingestion engine may also tag an article that has a negative sentiment to a subject matter but has a positive commercial effect to the commercial success of a company, a brand, a product, and/or a service, or a category thereof. For example, in FIG. 5, article 520 may report an accident where the victim was talking over a mobile phone while driving. The content ingestion engine may determine that the sentiment of the content in the article 520, which states that talking over a mobile phone while driving is dangerous, is negative to mobile phones in general, but the article has a positive effect to automobiles that have Bluetooth functions to connect to a smart phone with a speaker of the automobile, so that the problem of picking up a phone call while driving is resolved. Thus, although the article 520 has a negative sentiment towards mobile phones in general, the article may be an ideal VAC article for displaying a product of Dodge automobiles.

Alternatively, because the content database 402 allows an article to have multiple categories, the content ingestion engine may further categorize the VAC article based on the sentiment; or the VAC database may also be generated independent from the content database 432. The VAC database may be independently generated by a server as a hierarchical taxonomy, such as the YCT.

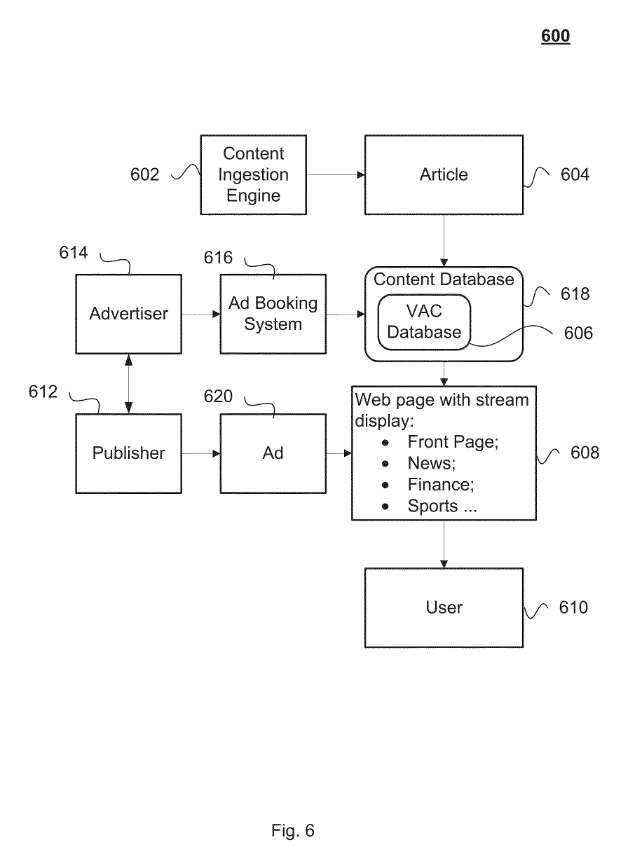

FIG. 6 is a flow chart illustrating operation of a value added in-stream content marketplace for online advertising according to the example embodiments of the present disclosure. The marketplace may include a website 608 that displays stream content on its web pages and a content database 618, such as the system 400 in FIG. 4, and an ad booking system 616. The content database 618 may include a VAC database 606

When a new article 604 is submitted to the website 608, the article 604 may first be categorized in a content database 618. Then a content ingestion engine 602 may conduct sentiment analysis to the article 604 and tag the article 604. As set forth above, the tagging may be based on a sentiment in the article towards a brand, a product, a company, a service provided by the company, or a category thereof. The brand, product, company, service, and category thereof may be a general classification or may be a specific client (e.g., advertiser) that purchases a VAC ad displaying service from the website 608. Based on the tag, the content ingestion engine may classify the article and organize the article into the VAC database.

If the article 604 is determined by the content ingestion engine 602 to be a VAC article, the content ingestion engine 602 or another server (e.g., a server of the website 608, not shown) may place the article 604 in the VAC database 606 for in-stream display on a web page of the website 608. The VAC database 606 may be a sub-database of the content database 618 or an independent database.

Further, the content ingestion engine 602 may analyze, categorize, and/or place tags to new articles periodically to generate and/or expand the VAC database. For example, the content ingestion engine 602 may analyze newly received articles on an hourly basis.

The VAC database 606 and the content ingestion engine 602 may be part of the website 608 or may be operated by independent third parties. The web page may be a homepage, front page, or a web page of specific topics, such as news, finance, and/or sports. As set forth above, in addition to slots for OIC articles, the stream on the web page of the website 608 may include predetermined slots for VAC articles and other items such as advertisements.

A publisher 612 may be in charge of displaying ads when articles in the VAC slots are read. The publisher may be the website 608 or may be an independent ad publisher. Through the ad booking system 616, the advertiser may opt to display its ads on webpage 608 of the VAC articles. For example, an advertiser such as Samsung may opt to buy out all VAC articles in the VAC database 606 that opine positively about a category “Mobile Phone.” If the advertiser 614 is a new client, the publisher 612 may add the advertiser 614 as a new brand, product, company, service, or a category thereof in the corresponding ad database. Accordingly, the content ingestion engine may analyze contents of the content database 618 to update the VAC database 606 for the new client.

When a user 610 accesses the website 608 and opens a webpage, such as webpage 402 (e.g., the front page, or news, finance, or sports board etc.), with a stream display, the server of the website 608 may first retrieve the online activity history of the user. Then the server may select a predetermined number of articles (e.g., 167 articles out of 175 slots available for stream display on the web page) from the content database 618 based on the online activity history of the user and display these articles as a stream on the webpage. Among these articles, a predetermined number of articles (e.g., 5 articles) may be selected from the VAC database 606 and placed in predetermined slots of the stream on the web page, such as slots 418a, 418b in FIG. 4.

Because the articles are specially designed based on the user's historical online activity history, such as online browsing history that reflects the user's personal interests, the selected articles may have higher likelihood to be clicked and read by the user. When the user selects and clicks the link in a VAC slot, e.g., slot 418a in FIG. 4, the user may be re-directed to a new page, such as a landing page, of full content of the VAC article, and an ad 620 from the advertiser 614 may be displayed in conjunction with the content. For example, slot 418a is linked to a VAC article related to a person's constitutional right to use mobile phones in a bank. The content ingestion engine has determined that the article has a positive sentiment towards using smart phone. When the user clicks the link on slot 418a, the link may direct the user to a new web page with a full story of the article, and an ad 620 from Samsung, for example, may be displayed in conjunction with the content of the article. The content of the advertisement may be consistent and/or compatible with the sentiment of the article so that the user may feel the ad naturally fits into the content of the article. For example, the ad 620 for Samsung may state “Use Samsung Galaxy™ at anywhere!” Further, the ad 620 may be displayed within the article adjacent to where the positive sentiment locates, or alternatively, the ad 620 may be displayed outside the content of the article, such as a banner above the article.

The service for displaying an ad with a VAC article may be available only to special advertisers of the website 608. For example, the service may be available only to premium advertisers that show ads on the front page of the website 608 or premium advertisers who buys Guaranteed Delivery services from the website 608. The publisher 612 may give an advertiser an option to buy out opportunities of displaying ad on articles in a VAC slot, or alternatively, the publisher 612 may sell the ad displaying opportunity through an auction.

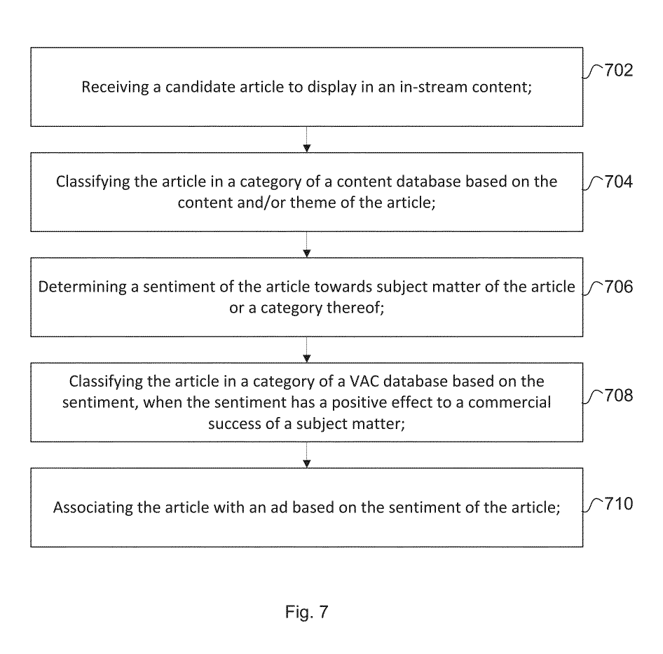

FIG. 7 illustrates a flow chart of a method for generating a value added in-stream content database according to exemplary embodiments of the present disclosure. The method may be implemented by at least one server, such as the servers 102, 106, 108 as shown in FIG. 1, which may have a structure shown in FIG. 2. The server may be used to support operations of a website, such as the website 400 in FIG. 4. The method may be stored in at least one non-transitory processor-readable storage medium in a form of at least one set of instructions. The at least one storage medium may be configured to communicate with at least one processor (hereinafter “the processor”) of at least one server. When the processor executes the at least one instructions, the at least one instructions may direct the processor to execute the following steps.

In step 702, the processor may receive a candidate article to display in a stream on a web page. The candidate article may be any article available to display on a website supported by the server and considered as a candidate of a VAC database. For example, the article may be a newly submitted article to the website, or an existing article in the website not yet analyzed to be a VAC article.

In step 704, the processor may classify the received candidate article to a category based on the content and/or theme of the article. The category may be a category in a content database having a plurality of articles to display on the web page. Further the content database may be organized as a hierarchical taxonomy. Detailed steps of classifying an article into a content database have been introduced in FIG. 5.

In step 706, the processor may analyze the content of the article and determine if the content includes a sentiment towards a subject matter or a category of subject matter. Methods and steps of the sentiment determination may be the same as that set forth in FIG. 4. For example, the processor may analyze the content of the article and determine the sentiment thereof periodically, before and/or after an advertiser opts in a VAC advertising arrangement. The subject matter may be a category in the content database that the article belongs to. The subject matter may also be a category that the article does not belong to. Further, the subject matter may be a product, a service, a brand of the product or service, a company that possess the brand, product, and/or service, or a category thereof.

The sentiment may be positive towards the subject matter, so that it has a positive effect to a commercial success of the subject matter. For example, the article in VAC slot 418a states that using mobile phones in a bank is constitutional. The article includes an attitude and opinion that is positive to using mobile phone, thereby is positive towards the commercial successful of mobile phone products.

Alternatively, the sentiment may be negative towards the subject matter but have a positive effect towards a commercial success of another subject matter. For example, an article that introduces an accident caused by making phone calls while driving has a negative attitude and opinion towards using mobile phone. But it has a positive effect towards automobiles that provide Bluetooth communications between a speaker of the automobile and a mobile device.

In step 708, if the article is determined to be a VAC article, the processor may tag the article and, based on the tag, the content ingestion engine may classify the VAC article and organize the VAC articles into the VAC database. The tag may associate the article with the subject matter to which the sentiment has a positive effect towards its commercial success.

Alternatively, the processor may classify the article in a category based on the sentiment of the article. For example, for the article that reports the accident when the victim was using a mobile phone while driving, the processor may categorize the article under automobile with Bluetooth functions. Details of generating a VAC database have been introduced in FIG. 4.

In step 710, the processor may associate the article with an ad based on the sentiment of the article. The processor may associate the article with the ad individually, wherein the content of the ad is consistent and/or compatible with the sentiment of the article. Alternatively, the processor may associate the category of the article with the individual advertisement. For example, the processor may associate an ad of Samsung Galaxy™ with entire articles under a VAC category “Mobile Phones” of the VAC database. Further, the processor may associate the article with the ad by associating the VAC database with an ad database.

To this end, the processor may generate a mapping table to make the association. The ad database may be organized under a hierarchical taxonomy. For example, the ad database may be organized based on brand, product, service, or company names that an ad advocates. Accordingly, the mapping table may associate a category in the VAC database with a category in the ad database based on a match between the subject matter of the categories.

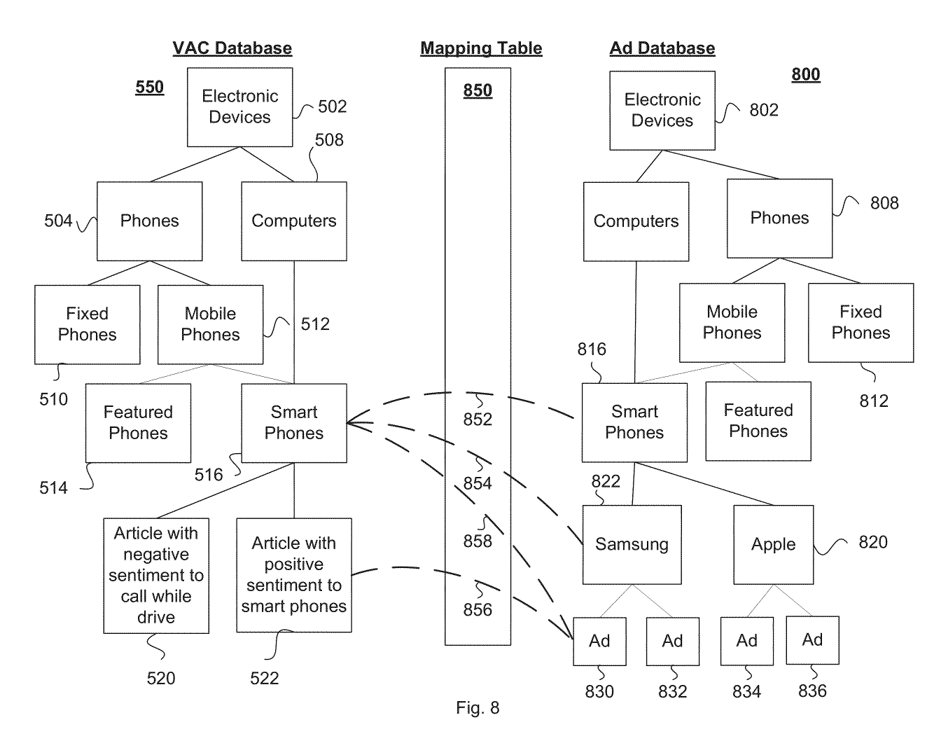

FIG. 8 illustrates a mapping table that associates a VAC database with an ad database. FIG. 8 includes a VAC database 550, a mapping table 850, and an ad database 800. For illustration purpose, the VAC database 550 in FIG. 8 may be considered to be a sub-database of the content table 500 in FIG. 5, i.e., the VAC database 550 may include all VAC articles (e.g., the articles 520 and 522) in the content database 500 and share the same taxonomy structure as the content database 500. The ad database 800 may have a same taxonomy structure as the VAC database 550 or a taxonomy structure compatible with the VAC database 550 so that a match between the two databases on a taxonomy level is possible.

The mapping table 850 may associate individual articles in the VAC database 550 with individual ads in the ad database 800. For example, Samsung may have an ad 830 for Galaxy™ smart phone in the ad database 800. The mapping table 850 may include an association 856 that associate the ad 830 with the article 522, which states that using mobile phones in a band is constitutional.

The mapping table 850 may also associate an individual ad in the ad database 800 with categories in the VAC database 550. For example, the ad 830 may be associated with the content category “Smart Phones” 516 through an association 858, so that when a VAC article under the category “Smart Phones” 516 is selected to display on the web page 400, the ad 830 will be displayed.

Further, the mapping table 850 may associate the VAC database 550 with the ad database 800 on the taxonomy level. For example, Samsung may be an advertiser registered in the ad booking system 616 to buy out all VAC articles under the VAC category “Smart Phones.” Accordingly, the processor may generate an ad category “Samsung” 822 in the ad database 800. All qualified ads of Samsung smart phone may be classified under this category. The processor may also generate an association 852 in the mapping table 850 to associate the VAC category “Smart Phones” 516 with the ad category “Samsung” 822. When a VAC article (e.g., article 522) under the VAC category “Smart Phone” 516 is selected to be displayed on the web page 400, the processor may select any ad under the ad category “Samsung” 822 to display on the web page 400. In a similar manor, the mapping table 850 may also associate the VAC category “Smart Phones” 516 with the ad category “Smart Phones” 816 through an association 852.

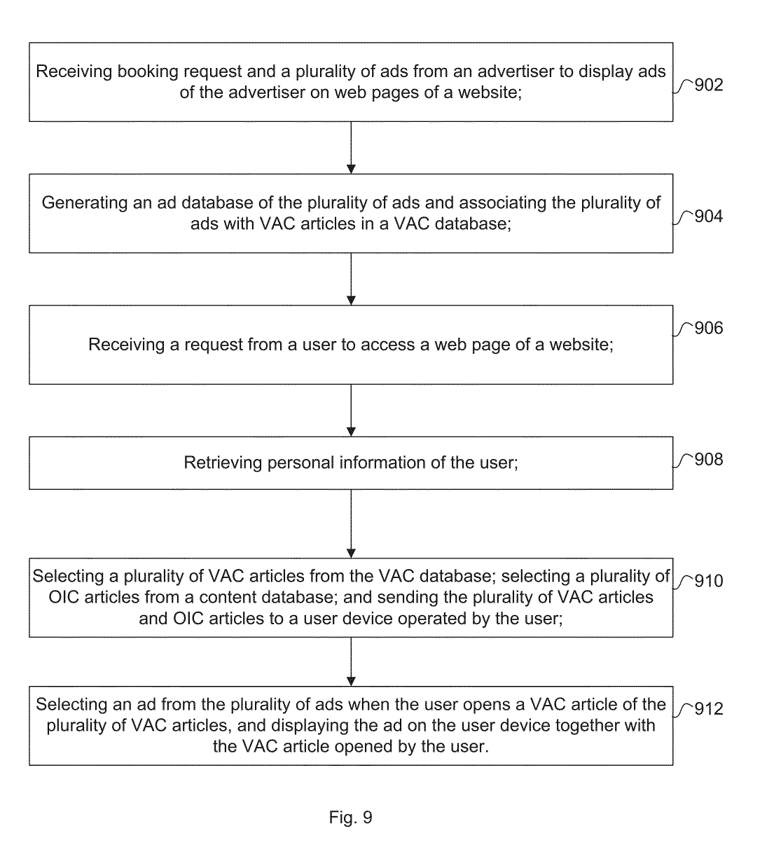

FIG. 9 is a flow chart illustrating a method for operating a VAC marketplace according to the example embodiments of the present disclosure. The method may be implemented by at least one server such as servers 102, 106, 108 as shown in FIG. 1, which may have a structure as shown in FIG. 2. The method may be stored in at least one non-transitory processor-readable storage medium in a form of at least one set of instructions. The storage medium may be configured to communicate with at least one processor (hereinafter “the processor”) of at least one server. When the processor executes the at least one instructions, the at least one instructions may direct the processor to execute the following steps.

In step 902, the processor may receive a booking request and a plurality of ads from an advertiser to display the ads on web pages of a website. The booking request may specify specific topics and conditions and requirements of the ad display. For example, the advertiser may request to display a plurality of ads on an article that is related to mobile phones.

In step 904, the processor may generate an ad database for the ads provided by the advertiser. The ad database may be a database such as the database 800 as introduced in FIG. 8. Further the processor may generate a mapping table to associate the ads with VAC articles in a VAC database.

In step 906, the processor may receive a request from a user to access a web page of a website, such as the web page 402 in FIG. 4. The web page may be a premium page for ad displaying. For example, the web page may be a homepage, front page, a board of a specific topic, such as sports, news, finance, of the website.

In step 908, the processor may retrieve personal information of the user. The personal information of the user may be his/her demographic information and/or his/her historical online activity information.

In step 910, the processor may select a plurality of VAC articles from the VAC database based on the personal information of the user. For example, the VAC article may be selected based on personal interest of the user that is reflected through his/her historical online activities. The processor may rank all the VAC articles in the VAC database that are qualified under the advertiser's specific conditions and/or requirements, and pick up the VAC articles that match the personal information of the user best. For example, if the advertiser requires its ad be displayed in VAC articles related to mobile phones and if there are 500 VAC articles in the VAC database satisfy this requirement, the processor may determine a degree of match between each of the 500 VAC articles and the user's personal interest. If there are 5 slots available on the web page 402 to display the VAC articles, the processor may select the top 5 VAC articles from the 500 VAC articles that best fit the personal interest of the user to enhance likelihood that one or more of the 5 selected VAC articles are read by the user.

The processor may also select a plurality of OIC articles from a content database based on the personal information of the user (e.g., the personal interest of the user), wherein the content database includes a plurality of OIC articles. Then the processor may send the selected VAC articles together with the OIC articles to a user device of the user to display therein. The OIC articles and the VAC articles may be displayed as a stream on the user device, wherein each of the plurality of VAC articles is placed on a predetermined position of the stream.

In step 912, the processor may select an ad of the advertiser from the ad database when the user select a VAC article from the web page and open the article in a second web page. The processor then may display the selected ad on the second web page of the VAC article.

The selection of the ad may be based on a match between the sentiment of the VAC article opened by the user and the content of the ad to be displayed with the article. The content of the ad may be consistent and/or compatible with the sentiment of the article, and/or enhance the interest of the user to read the ad. To this end, the processor may determine a match between each of the ad provided by the advertiser and the VAC article opened by the user. The processor then may select the ad that matches the VAC article best, i.e., select the ad with the highest likelihood to fulfill the purpose of the ad. For example, if realization of the ad is calculated by a click through rate, the processor may select the ad that has the highest likelihood of being clicked through when being displayed on the second web page.

As described above, the example embodiments of the present disclosure provide systems and methods for establishing a VAC database. By selecting articles with positive sentiment towards an advertiser, the systems and methods may generate a VAC database to display VAC articles in a stream. When a user opens a website with stream display, the systems and methods may select a VAC article from the VAC database to be displayed on the web page.

The example embodiments of the present disclosure also provide systems and methods for placing an ad in a VAC article. The systems and methods may also generate an ad database and generate a mapping table that associate an ad with a VAC article. When the user opens the VAC article in a second web page, the systems and methods may provide the ad in the second web page based on the mapping table.

Further, the example embodiments of the present disclosure provide systems and methods for establishing a VAC marketplace. The systems and method may generate the VAC database, the ad database, and the mapping table according to an advertiser client and specific requirements of the advertiser client. When the user opens the VAC article in a second web page, the systems and methods may provide an ad of the advertiser client in the second web page based on the mapping table.

However, it is intended that the foregoing detailed description be regarded as illustrative rather than limiting, and that it be understood that it is the following claims, including all equivalents, that are intended to define the spirit and scope of this invention.

For example, while the above-described systems and methods adopts a sentiment in the article as analysis criteria for ad displacement, the same systems and methods may adopt other criteria, such as a sentiment of a comment that follows the article in the web page as criteria for ad displacement.

Further, while the above-described systems and methods have been described with respect to website with stream display, it will be appreciated that the same systems and methods may be implemented to a website without stream display.

In addition, while example embodiments have been particularly shown and described with reference to FIGS. 1-9, it will be understood by one of ordinary skill in the art that various changes in form and details may be made therein without departing from the spirit and scope of example embodiments, as defined by the following claims. The example embodiments, therefore, are provided merely to be illustrative and subject matter that is covered or claimed is intended to be construed as not being limited to any example embodiments set forth herein. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

We claim:

1. A server system, comprising:
at least one non-transitory, processor-readable storage medium including at least one set of instructions for generating a value added in-stream contents (VAC) database for ad display; and
at least one processor in communication with the at least one storage medium, the at least one processor configured to execute the at least one set of instructions to:
receive a candidate content item for display in a stream on a website;
determine a sentiment of the candidate content item towards a first subject matter associated with the candidate content item;
classify the candidate content item to a first type category based on the sentiment when the sentiment has a positive effect to a commercial success of a second subject matter; and
generate a VAC database based on the first type category.

2. The server system according to claim 1, wherein the first subject matter comprises at least one of a brand, a product, a service, a company, and a category thereof.

3. The server system according to claim 1, wherein the sentiment is positive to the first subject matter, and
the second subject matter is associated with an ad to be displayed with the candidate content item on a web page.

4. The server system according to claim 1, wherein the sentiment is negative to the first subject matter, and
the second subject matter is associated with an ad to be displayed with the candidate content item on a web page.

5. The server system according to claim 1, wherein the at least one processor is further configured to execute the at least one set of instructions to classify the candidate content item to a second type category of a content database based on content of the candidate content item, wherein:
the content database includes a plurality of second type categories,
the plurality of second type categories is organized as a hierarchical taxonomy, and
each of the plurality of categories includes a plurality of content items,
the VAC database includes a plurality of first type categories,
each of the plurality of first type categories includes a plurality of content items; and
the plurality of second categories is organized as a hierarchical taxonomy.

6. The server system according to claim 5, wherein:
the stream comprises a list of content items displayed one by one on the web page; and
the list of content items is selected from the plurality of content items from the content database and the plurality of content items from the VAC database based on an online activity history of a user who is accessing the web page.

7. The server system according to claim 5, wherein the at least one processor is further configured to execute the at least one set of instructions to:
receive an ad database including a plurality of ad categories,
wherein each of the plurality of ad categories includes a plurality of ads,
wherein the plurality of ad categories is organized as a hierarchical taxonomy; and
generate a mapping table associating the VAC database with the ad database.

8. A processor-implemented method for generating a value added in-stream contents (VAC) database for ad display, the method comprising:
receiving, by a processor, a candidate content item for display in a stream on a website;
determining, by a processor, a sentiment of the candidate content item towards a first subject matter associated with the candidate content item;
classifying, by a processor, the candidate content item to a first type category based on the sentiment when the sentiment has a positive effect to a commercial success of a second subject matter; and
generating, by a processor, a VAC database based on the first type category.

9. The method according to claim 8, wherein the first subject matter comprises at least one of a brand, a product, a service, a company, and a category thereof.

10. The method according to claim 8, wherein the sentiment is positive to the first subject matter, and
the second subject matter is associated with an ad to be displayed with the candidate content item on a web page.

11. The method according to claim 8, wherein the sentiment is negative to the first subject matter, and
the second subject matter is associated with an ad to be displayed with the candidate content item on a web page.

12. The method according to claim 8, further comprising classifying, by a processor, the candidate content item to a second type category of a content database based on content of the candidate article, wherein:
the content database includes a plurality of second type categories,
the plurality of second type categories is organized as a hierarchical taxonomy, and
each of the plurality of categories includes a plurality of content items,
the VAC database includes a plurality of first type categories,
each of the plurality of first type categories includes a plurality of content items; and
the plurality of second categories is organized as a hierarchical taxonomy.

13. The method according to claim 12, wherein:
the stream comprises a list of content items displayed one by one on the web page; and
the list of content items is selected from the plurality of content items from the content database and the plurality of content items from the VAC database based on an online activity history of a user who is accessing the web page.

14. The method according to claim 12, further comprising:
receiving, by a processor, an ad database including a plurality of ad categories,
wherein each of the plurality of ad categories includes a plurality of ads,
wherein the plurality of ad categories is organized as a hierarchical taxonomy; and
generating, by a processor, a mapping table associating the VAC database with the ad database.

15. A non-transitory, processor-readable storage medium comprising at least one set of instructions for generating a value added in-stream contents (VAC) database for ad display, wherein the at least one set of instructions, when executed by at least one processor, is configured to direct the at least one processor to perform acts of:
receiving a candidate content item for display in a stream on a website;
determining a sentiment of the candidate content item towards a first subject matter associated with the candidate content item;
classifying the candidate content item to a first type category based on the sentiment when the sentiment has a positive effect to a commercial success of a second subject matter; and
generating a VAC database based on the first type category.

16. The storage medium according to claim 15, wherein the first subject matter comprises at least one of a brand, a product, a service, a company, and a category thereof.

17. The storage medium according to claim 15, wherein the sentiment is positive to the first subject matter, and
the second subject matter is associated with an ad to be displayed with the candidate content item on a web page.

18. The storage medium according to claim 15, wherein the sentiment is negative to the first subject matter, and
the second subject matter is associated with an ad to be displayed with the candidate content item on a web page.

19. The storage medium according to claim 15, wherein the at least one set of instructions is further configured to direct the at least one processor to perform acts of:
classifying the candidate content item to a second type category of a content database based on content of the candidate content item, wherein:
the content database includes a plurality of second type categories,
the plurality of second type categories is organized as a hierarchical taxonomy, and
each of the plurality of categories includes a plurality of content items,
the VAC database includes a plurality of first type categories,
each of the plurality of first type categories includes a plurality of content items; and
the plurality of second categories is organized as a hierarchical taxonomy.

20. The storage medium according to claim 19, wherein:
the stream is a list of content items displayed one by one on the web page; and
the list of content items are selected from the plurality of content items from the content database and the plurality of content items from the VAC database based on an online activity history of a user who is accessing the web page.
